(19) United States
(12) Patent Application Publication
(10) Pub. No.: US 2015/0180912 A1
(43) Pub. Date: Jun. 25, 2015

(54) METHOD AND SYSTEM FOR DATA TRANSFER BETWEEN TOUCHSCREEN DEVICES OF SAME OR DIFFERENT TYPE

(71) Applicant: Mobigloo LLC, Miami Beach, FL (US)

(72) Inventor: Sylvain Dufour, Miami Beach, FL (US)

(73) Assignee: Mobigloo LLC, Miami Beach, FL (US)

(21) Appl. No.: 14/135,920

(22) Filed: Dec. 20, 2013

(51) Int. Cl. H04L 29/06; G06F 3/0481; H04W 4/02; G06F 3/0486; G06T 1/20; G06F 3/041

(52) U.S. Cl. CPC H04L 65/403; G06T 1/20; G06F 3/0416; H04W 4/02; G06F 3/0486; G06F 3/04817

(57) ABSTRACT

The invention is a method and system for dragging and dropping a file between a first and second device such as two smart phones. No direct connection between devices is made and pairing is accomplished by a series of successive criteria matching steps over a server or the internet.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to transferring data such as in file or other format between a first and second device. In particular, it relates to a method and system for drag and drop sharing of data such as a photo, links, contacts, appointments, either within a file or not, between a first and second device having touchscreens, such as between smart phones even wherein they are of the same or different type (e.g. between Apple™ and Android smart phones).

2. Description of Related Art

The desire to share files between electronic devices has become more and more popular as people download more files and cameras have become standard items on smart phones, tablets, laptops, cameras and the like, especially those devices that travel. The movement of data files such as photos or other data files, between electronic devices such as cell phones or computers or the like has become increasingly sophisticated in an attempt to meet the demand for fast and easy file sharing between two devices.

A number of methods and systems have been developed for sharing files between a first and second device. One method involves a user sitting at a first computer electronically connecting a first and second computer and bringing the second computer onto the screen of the first computer such that the screen of the second computer appears on the first computer, e.g. remote desktop protocol. Files can then be transferred on the single screen by standard methods such as drag and drop using a mouse on the single screen since at that point the files are essentially on one computer.

Where one does not wish to give over control of the computer to someone, more recent advances have been utilized. Android devices can share files by use of a combination of Near Field Communications (NFC) and Bluetooth. In some embodiments, the exchange is initiated by “bumping” the devices together which initiates transfer by engaging motion detectors in the smart phones. Apple™ devices can use Bluetooth connection between the devices to create a peer-to-peer Wi-Fi network between Apple™ devices. Each device creates a firewall around the connection and files are sent encrypted, which can make it safer than transferring via email but time consuming to initiate. The Apple™ “air drop” method will automatically detect nearby supported Apple™ devices, and the devices need to be close enough to establish a good Wi-Fi connection directly between the devices.

These methods are limited to just between Android devices or just between Apple™ devices and connections are directly between the phones leading to security issues and exposure to viruses and the like. In some cases, it is difficult to limit who receives the file or photo while in other cases there must be an initialization directly between the first and second device or a registration event to approve the transfer and allow the exchange to occur.

### BRIEF SUMMARY OF THE INVENTION

The present invention relates to the discovery of the method of dragging and dropping data (in files or not) from one device to another, such as over a network such as the internet or other means where successive comparisons match the drag and drop event from a sending to a receiving device.

Accordingly, in one embodiment there is a method of transferring a first data on a first touchscreen device to a second touchscreen device utilizing a server over a network comprising:
a) a software application which recognizes a dragging motion of the first data on the first touchscreen device sends the first data to the server over the network and information about the dragging motion;
b) a software application which recognizes the dropping motion of a data on the second touchscreen device and collects information about the dragging motion;
c) matching the recognized dragging motion and dropping motion by successive comparison criteria until an unambiguous match occurs; and
d) if an unambiguous match occurs, the server delivering the first data to the second device over the network.

In another embodiment, a system for transferring a first data on a first touchscreen device to a second touchscreen device utilizing a server over a network comprising:
a) a first software application which recognizes a dragging motion of the first data on the first touchscreen device which can send the first data to the server over the network and collect information about the dragging motion;
b) a second software application which recognizes the dropping motion of data on the second touchscreen device which can collect information about the dragging motion;
c) a computer program capable of matching the dragging motion and dropping motion by successive comparison criteria until an unambiguous match occurs; and
d) wherein if an unambiguous match occurs, the server can deliver the first data to the second device over the network.

### BRIEF DESCRIPTION OF THE DRAWINGS

FIG. 1 is a graphic of a drag and drop between two smart phones.

FIG. 2 is the graphic of a file transfer between two devices.

FIG. 3 is a flow chart of the method of the invention.

FIG. 4 is a flow chart of matching touchscreen devices by making successive comparisons to obtain an unambiguous match.

### DETAILED DESCRIPTION OF THE INVENTION

While this invention is susceptible to embodiment in many different forms, they are shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

### DEFINITIONS

The terms “about” and “essentially” mean±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

Reference throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are for the purpose of illustrating certain convenient embodiments of the present invention, and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein, the term “transferring” refers to a copy of digital data, optionally in a file, on a first touchscreen device being copied and sent to a server over a network such as the internet and a copy sent to a second touchscreen device from the server. In other embodiments it refers to a direct transfer of data from a first to a second device. It can include transfer of a screen icon, as well, so that the icon appears on the screen to help indicate the transfer of the data and an icon to open the data. It can also mean that the original data on the first device is either deleted or a copy left there. Other data, in some embodiments, can be transferred from a server or other location to the second device such as advertisements, messages and the like.

As used herein, the term “a first data” refers to any type of data to be transferred from one device to another such as at least one of the following: a word processing document, a photo(s), a PDF file, links, contacts, appointments, either in a file or not or the like. In general, the data is represented by an icon on the screen of the user. Such icons are within the skill in the art and one skilled in the art understands what digital data is and how to copy data (in a file or not) and upload it to the internet or from one device directly to another.

As used herein, the term “touchscreen device” refers to a computer type device with a touchscreen on it such as a smart phone, laptop, camera, tablet or the like. Typically, these devices allow for drag and drop function solely on the device itself to transfer between locations on the same device. Any device that can accommodate software to drag and drop files by touchscreen is intended though examples herein may be limited to smart phones. The first device is the sending device and the second device is the receiving device intended to receive the data and an accompanying icon (or anything else desired to be sent along with the first data such as advertisements, messages and the like intended for one of the devices.)

As used herein, the term “network” refers to the world wide web, the internet, an intranet or any other forms of these now or in the future regardless of the form taken. In general, it is a collection of connected computer type devices, interconnected for the purpose of communication and digital data exchange. “Over a network” means to be connected to the network and capable of transferring data from one device to another utilizing the known methods for data transfer on a network such as the internet. The network connection may be, for example, wifi or it may be connected via a cell phone tower from a device or the like.

As used herein, the term “computer” refers to a standard computing device that will have a central processing unit (CPU) or a group of CPUs that access it or their own individual non-cache Random Access Memory. As used herein a “server” refers to one or more computers which can serve as a transfer agent over the network and can have the resident memory software to perform comparisons as described herein between the drag and drop motions and can accept data delivery from the first device and deliver to the second device over the network. It can also accept other data types or deliver other types of information (advertisement etc.). In an embodiment, a large number of clients having devices can be accommodated at the same time. One skilled in the art could set up the software, databases and functions on a server based on the descriptions herein without undue experimentation.

As used herein, the term “drag and drop” for purposes of this patent, refers only to drag and drop function of transferring data from a first touchscreen device to a second touchscreen device. Typically, drag and drop will be placing a finger (or the like) on the data icon on the first touchscreen device and sliding the finger to drag to a desired location and lifting the finger to drop the data icon at the desired second touchscreen device which transfers the data from the first to second location. In the present invention, the drag starts on a first device and ends on a second device even if there is space between the two devices or not. Those skilled in the art understand the programming and application of drag and drop. For purposes herein it does not include transfer by mouse or the like, only on touch based screens of two separate devices. In the performance of a drag and drop operation, the two computers e.g. two smart cell phones, can be placed on a flat surface or other desired location and a dragging motion of the data icon is made on the first device until the finger leaves the device edge. The finger then moves to the second device and concludes the slide and drop motion on the second device screen in a desired location on the screen. Since this method can be cloud based with software applications (apps) on each device, the type of device, e.g. Apple™ or Android™, is immaterial to the process and problems with different smart phones, tablet types etc. are avoided. No registration is necessary and the devices do not need to be in contact or otherwise already connected. Where devices are already connected wirelessly, transfer can be directly between devices.

As used herein, the term “software application” refers to software in resident memory on a computer (the sending and receiving device) which operates on the touchscreen devices to recognize that a dragging operation has been done on the first device. Upon recognition of the event, the application (referred to as an “app”) can send notice of the event to the server or other location along with the first data and optionally an icon representing the data as desired. It can also, in one embodiment, collect information about the sending device to help identify who is doing the sending. Rather than personal information such as the user name, the cell phone number or other identity information, the information that is collected is generally about the sending device and receiving device which identifies phone characteristics rather than user characteristics for the purpose of matching the drag and drop action. This avoids the need for user verification on both sides before a transfer occurs but as shown hereafter still guarantees transfer between the correct desired devices regardless if there has been user verification. Such things as device location, the orientation of the device (e.g. the degrees of the smart phone oriented to north or upright or the like) time of the drag and drop, direction the drag and transferred drop (to left or right), location of the start of drag and drop on the screen. Altitude, ambient noise around the device, or any other measurement characteristic of the device can be sent/used for comparisons. However, it does not include measurements made between a connected first and second device since at this point the second device is not identified. In fact, no connection between the devices directly need ever occur, though the comparisons work for connected devices as well.

In one embodiment, the receiving device can send/store information from the first device upon sensing a drop motion along with the same type of location information as the first device. All information can then be delivered to the server over the internet or at the desired location including remaining on the second device. In one embodiment, the software can include the comparisons of collected information on one or more devices instead of on the server as described below. The server can be eliminated where the devices are on the same network, wirelessly connected and the like.

The server having received the data, and in one embodiment the collection of information, from both a dragging motion on a first device and a dropping motion on a second device, can then make a comparison (optionally the server can be eliminated whereas the devices are on the same network, wirelessly connected—see above) to match the two devices together as the intended matched devices, i.e. the right drag and drop motions are paired to pair the devices. At any given moment, if there are multiple users of the system there will be multiple dragging motion device information and dropping motion information collected on devices and optionally on the server and the matching first and second device is unknown. There may be hundreds, thousands or even millions of dragging and dropping motion operations going on during the day and collected at any given moment. The server (or the devices) must make a series of successive comparisons of the collected information to match the proper drag and drop motion together to match the intended sending and receiving devices. The collected device information is used in that comparison. As used herein the term, “comparison criteria” refers to applying some criteria to the dragging and dropping collected information contained therein to determine which dragging motion is to be paired with which dropping motion and thus pairing the devices (rather than identifying or otherwise identifying the devices and giving permissions or registering the devices or users). In one embodiment, the time of the drag and drop motion on each device is collected and reported as information. The server or devices using software can measure the time difference between every drag and drop motion collected not yet matched. The software can then match the drag and drop motions that are only within a specific time limit, for example, only drag and drop motions that occur within about 5, 10, 15 seconds or the like are selected and it is assumed that the matching drag and drop will occur in the time period. The remaining drag and drop motions are considered not matches. If only one collected drag and one drop fall in that time period, the devices are matched and the data, icon, etc. are delivered to the receiving device from the server or dragged between devices. If this matching does not leave just one match, e.g. there are still a dozen possibilities of drag and drop matches, successive other matching criteria may be applied until there is only one possibility of a drag and drop match, i.e. an “unambiguous match” has occurred at that point. Other matching criteria can be matching the orientation as the devices sit on the table or held in the hand or the like during the drag and drop motion, e.g. parallel or off by so many degrees, say within about 18 to about 180 degrees or the like (e.g. showing similar headings). Other means of comparison may be obtaining geolocation (real-world geographic location of the devices), either with Wi-Fi positioning, GPS or cell-tower triangulation of each device and limiting the comparison to those devices are within a certain distance say one, two or three miles or more from the other. In another embodiment the starting point on the first device is compared to the ending spot on the second device and a decision if there are logical matches made. The ambient temperature or ambient noise by the devices could be compared. The altitude could be compared. The direction of the swipe could be compared (e.g. right to left or left to right). The comparisons are continued one at a time, sequentially or in any order, until there is only one drag and one drop motion that match. One way of prioritizing may be to pick first the comparison likely to remove a large number of non-matching devices such as by way of time. Criteria could, in an embodiment be successively narrower. If one runs out of comparison criteria without a successful match, then the drag and drop operation fails and the user must start the drag and drop motion again between two devices. However, by having a sufficient amount of successive criteria and making successive comparisons, it will only occasionally occur that a particular transfer will fail. Logically, this will depend on the number of users utilizing the system at any given moment, however, the system and method guarantees a match of devices without registration or other types of matching events especially local device matching. Again, if there is a match the drag and drop is completed in the usual fashion with the server delivering the data and icon and any other data desired such as messages, advertisements and the like to the receiving device. The order of comparisons is not critical but in one embodiment the time comparison, as described above, is utilized first.

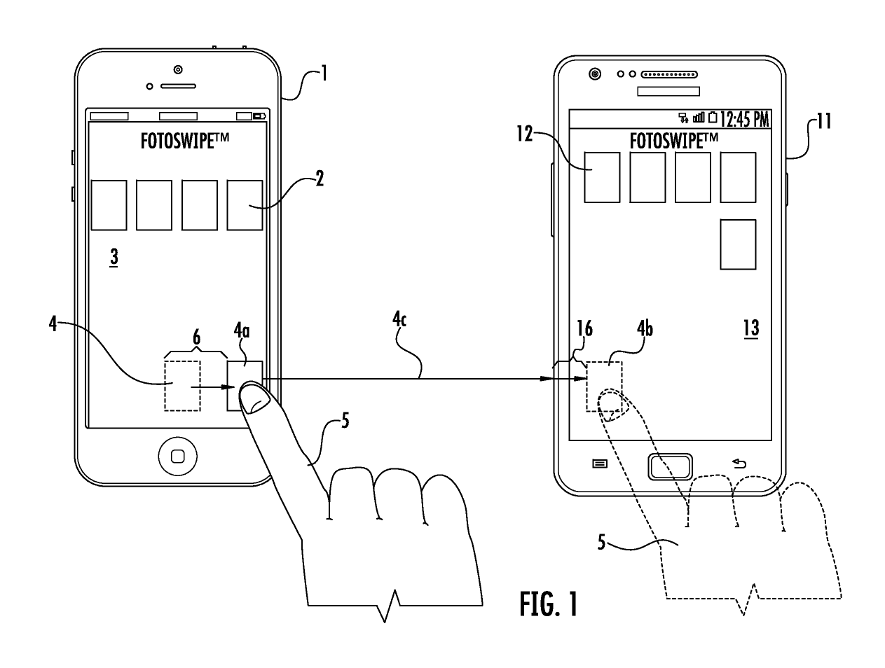

Now referring to the drawings, FIG. 1 is a graphic representation of a drag and drop event of the present invention between two devices. In this case, it is between two smart phones, one an Apple™ device and the other an Android™ device (in this case a Samsung™ device) each having a touchscreen. It is clear this could be between similar devices as well. In this figure, first touchscreen device 1 (an Apple™ smartphone), the sending device, is shown with an app opened with the icons representing digital photos 2 shown on touchscreen 3. User finger 5 is originally placed on icon 4 and in this view has drag swiped to the position 4a. The dragging motion 6 is shown across the screen 3. Arrow 4c indicates that the finger continues off screen 3 and into space landing on the second touchscreen device 11.

Also shown is second touchscreen device 11 (an Android™ smartphone) having an app open and several photo icons 12 depicted on screen 13. Arrow 4c indicates that the finger movement moves the icon from smart phone 1 over to position 4b on screen 13 the drop position. Dropping motion 16 is shown on screen 13.

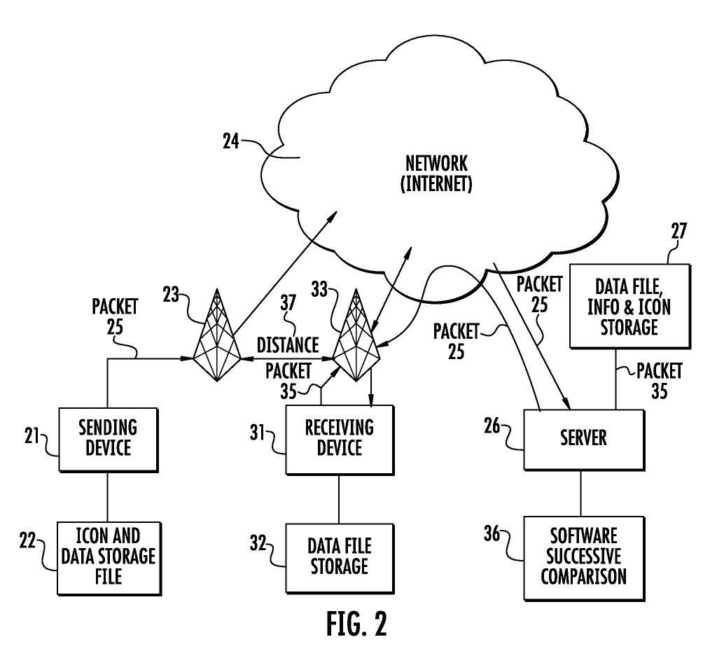

FIG. 2 is a graphic representation of the relationship between devices and the system used to transfer data from a first to a second device. Sending device 21 has a data storage 22 capability and using the method shown in FIG. 1 transfers drag motion info, icon and data and other desired data information in packet 25 to cell phone tower 23 and on to the Internet 24. The file 25 is delivered to server 26 and stored in digital storage 27. Receiving device 31 sends a packet 35 dropping information and device information to cell tower 33 and on to the internet 24 and then to server 26 also for placement in storage 27. The comparison software 36 (optionally on one or both of the devices) then compares data and info in packets 25 and 35 until an unambiguous match as described above is made. At that time, the server sends packet 25 (data and icon and any other desired additional information) over internet 24 back to receiving device 31 where it is stored in storage file 32.

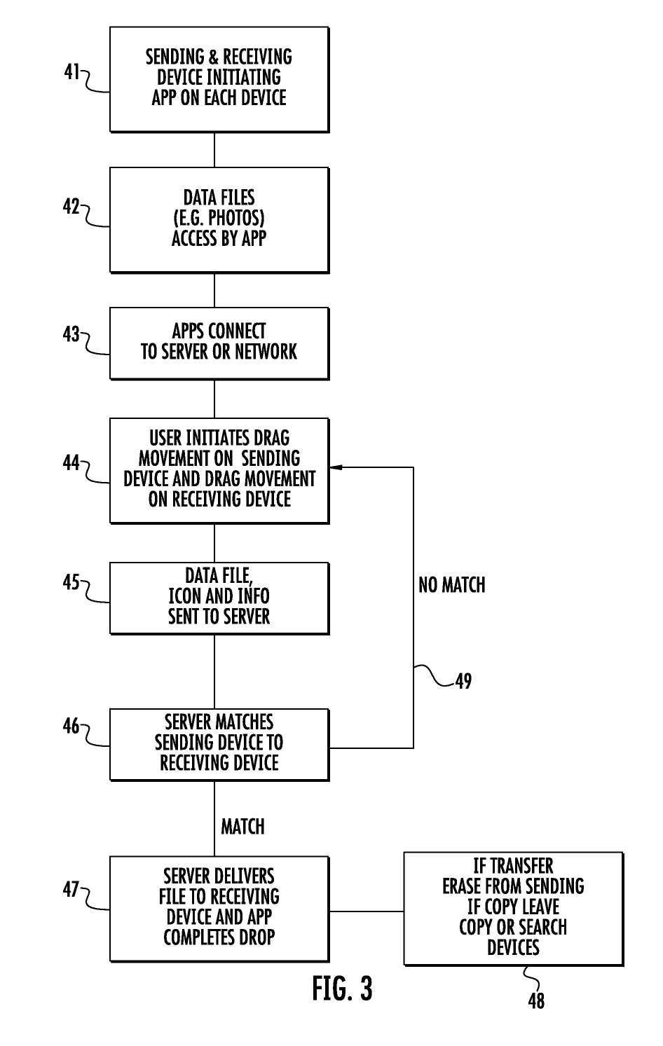

FIG. 3 is a flow chart of the method of the invention. Sending and receiving device initialize their app on each device 41. Once the app is initialized on the device, data icons (such as for photos) will be accessible by the app 42. The app then connects the device to the server on a network 43. This can be over a cell tower or other network (Internet) type connection. In other embodiments, the phones are directly connected or in a same wireless group or the like. Note some of these steps can be in other orders and no fixed order is implied by the figures. Note also the distance between cell towers 37 useful in the comparison matching process. The user then initiates a dragging motion of an icon on the sending device and a drop movement on the receiving device 44. The app on the sending device then sends the data (e.g. photo), icon collects information about the phone and any other desired information to the server or on the devices through the connection and the receiving device sends dropping motion and device information to the server 45. The server then matches the sending device to the receiving device 46 using a successive comparison criteria. In one embodiment the devices do the comparison. If it finds a match then the server delivers a file and icon to receiving device 47 allowing the drag and drop of the data to be completed. It is noted that in an embodiment the data can be deleted or left on the sending device 48. If no match is made 49 then the user must begin the drag and drop motion 44 over until a match 46 is made.

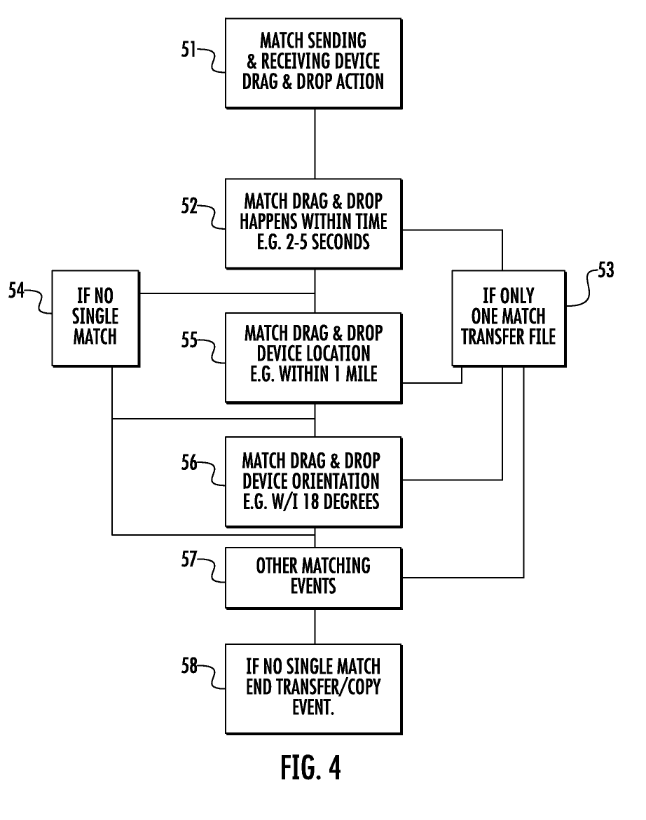

FIG. 4 depicts the process of matching a sending and receiving device by successive comparison criteria until an unambiguous match between the devices occurs for a particular drag and drop action. This method is either using a server or with the devices directly on a network. The software in the server on the device in resident memory on the server or devices process starts for matching a sending and receiving device 51. In this embodiment, the first comparison is to compare drag motions and drop motions to their time of occurrence and match those that occur within about 10 to 15 seconds of one another 52. If only one match, transfer data 53 to the receiving device. If there are more than one choices 54 of the matching devices then the next successive criteria is made and in this embodiment it is matching the orientation of the sending and receiving devices 56 (e.g. within 18 degrees.) Only those drag and drop devices within 18 degrees are now kept. Once again if only one match, the data are transferred 53 and if no single match a next successive criteria is used. In this example, the device locations are compared for proximity. In this case it is a match if they are within 1 mile though one could select any desired distance 55. Other comparisons can be made 57 in the event the first three do not provide an unambiguous match. If no single match occurs and there are no further criteria available, the transfer fails 58 and the user must start the drag and drop process a second time.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials and the like apparent to those skilled in the art still fall within the scope of the invention as claimed by the applicant.

What is claimed is:

1. A method of transferring a first data on a first touchscreen device to a second touchscreen device utilizing a server over a network comprising:
a) a software application which recognizes a dragging motion of the first data on the first touchscreen device sends the first data to the server over the network and information about the dragging motion;
b) a software application which recognizes the dropping motion of a data on the second touchscreen device and collects information about the dragging motion;
c) matching the recognized dragging motion and dropping motion by successive comparison criteria until an unambiguous match occurs; and
d) if an unambiguous match occurs, the server delivering the first data to the second device over the network.

2. The method according to claim 1 wherein the server places a first data icon on the location on the second touchscreen device that the dropping motion occurred when it delivers the first data file to the second touchscreen device.

3. The method according to claim 1 wherein the comparison criteria comprises at least one of: time between motions, distance between devices, location of the devices, location of the start of the drag on the first touchscreen and the drop on the second touchscreen device, and orientation of the first to the second device.

4. The method according to claim 3 wherein the first comparison criteria by the server is a comparison of the time between the dragging motion and the dropping motion.

5. The method according to claim 3 wherein the time between drag and drop motions is about 2 and 4 seconds.

6. The method according to claim 3 wherein the orientation of the first device to the second device is within about eighteen degrees.

7. The method according to claim 3 wherein the distance between the location of the first and second device is determined by the means selected from the group consisting of Wi-Fi positioning, GPS, and cell-tower triangulation.

8. The method according to claim 1 wherein the data file is one or more photos.

9. The method according to claim 1 wherein at least one of the devices is a smart phone.

10. The method according to claim 1 wherein at least one of the devices are connected to the internet over a cell tower.

11. The method according to claim 1 wherein the first data can be selected to be deleted or left on the first touchscreen device after transfer to the second touchscreen device.

12. The method according to claim 1 wherein an icon representing the first data is delivered to the server from the first device and delivered to the second device along with the first data and placed on the second device touchscreen where the drop motion occurred.

13. The method according to claim 1 wherein the data is contained in a file.

14. The method according to claim 1 wherein the matching is done on the server.

15. The method according to claim 1 wherein the matching is done on either the first or second touchscreen device.

16. A system for transferring a first data on a first touchscreen device to a second touchscreen device utilizing a server over a network comprising:
a) a first software application which recognizes a dragging motion of the first data on the first touchscreen device which can send the first data to the server over the network and collect information about the dragging motion;
b) a second software application which recognizes the dropping motion of data on the second touchscreen device which can collect information about the dragging motion;
c) a computer program capable of matching the dragging motion and dropping motion by successive comparison criteria until an unambiguous match occurs; and
d) wherein if an unambiguous match occurs, the server can deliver the first data to the second device over the network.

17. The system according to claim 16 wherein the first software application allows a selection of keeping or deleting the first data on the first device after the first data is transferred to the second device.

18. The system according to claim 16 which comprises the first and second device connected to the internet over a cell tower.

19. The system according to claim 16 wherein the collected information of the first and second device is matched utilizing a software program on the server by successive comparison.

20. The system according to claim 16 wherein the collected information of the first and second device is matched on at least one of the first and second devices by successive comparison.

21. A method of matching a first touchscreen device dragging motion to a second touchscreen device dropping motion for data transfer comprising making successive comparison criteria until an unambiguous match occurs and then transferring the data from the first device to the second device.
